(19) United States
(12) Patent Application Publication
(10) Pub. No.: US 2012/0281541 A1
(43) Pub. Date: Nov. 8, 2012

(54) Signaling Describing the Operation of a Link Bundle

(75) Inventors: Alastair Marcus Palmer, Woburn Sands (GB); Peyman Owladi, Harpenden (GB); Neil Robert Ketley, Marlow (GB)

(73) Assignee: Cisco Technology, Inc., a corporation of California, San Jose, CA (US)

(21) Appl. No.: 13/100,496

(22) Filed: May 4, 2011

(51) Int. Cl. H04L 12/56; H04L 12/26

(52) U.S. Cl. 370/241; 370/389

(57) ABSTRACT

In one embodiment, a first device communicates with a second device, including sending and receiving one or more link bundle control packets and/or link control packets over a link bundle. The link bundle includes a plurality of links with each link being coupled between the first device and the second device for communicating information. These link bundle control packets are directed at the operation of the link bundle in its entirety; while the link control packets which are directed to the operation of a corresponding single particular link. The first device communicates with the second device, including operating the link bundle according to these one or more link bundle control packets and/or link control packets.

### TECHNICAL FIELD

The present disclosure relates generally to communicating information with a remote device over a link bundle of communications links.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

The IEEE 802.3ad Link Bundling feature provides a method of aggregating multiple Ethernet links into a single logical channel. This feature helps improve the cost effectiveness of a device by increasing cumulative bandwidth without requiring hardware upgrades. In addition, IEEE 802.3ad Link Bundling provides a capability to dynamically provision, manage, and monitor various aggregated links.

### BRIEF DESCRIPTION OF THE DRAWINGS

The appended claims set forth the features of one or more embodiments with particularity. The embodiment(s), together with its advantages, may be best understood from the following detailed description taken in conjunction with the accompanying drawings of which:

FIG. 1 illustrates a network and devices operating according to one embodiment;

FIG. 2 illustrates an apparatus, device or component used in one embodiment;

FIG. 3 illustrates a process performed in one embodiment; and

FIGS. 4A-D illustrate various information communicated in link bundle control packets in one embodiment.

### DESCRIPTION OF EXAMPLE EMBODIMENTS

### 1. Overview

Disclosed are, inter alia, methods, apparatus, computer-storage media, mechanisms, and means associated with signaling describing the operation of a link bundle. In one embodiment, a first device communicates with a second device, including sending and receiving one or more link bundle control packets and/or link control packets over a link bundle. The link bundle includes a plurality of links with each link being coupled between the first device and the second device for communicating information. These link bundle control packets are directed at the operation of the link bundle in its entirety; while the link control packets are directed to the operation of a single particular link over which the corresponding link control packet was sent. The first device communicates with the second device, including operating the link bundle according to these one or more link bundle control packets and/or link control packets.

In one embodiment, a first device communicates with a second device, including sending and receiving one or more link bundle control packets over a link bundle. The link bundle includes a plurality of links with each link being coupled between the first device and the second device for communicating information. These link bundle control packets are directed at the operation of the link bundle in its entirety (e.g., in contrast to directing the operation of a single particular link as done by a link control packet). These link bundle control packets are communicated over one or more of the links in the link bundle, and typically may be communicated over all links in the link bundle, or at least the active links in the link bundle. The first device communicates with the second device, including operating the link bundle according to these one or more link bundle control packets.

In one embodiment, said one or more link bundle control packets includes an identification of an operational state of the link bundle as being active. In one embodiment, said using the link bundle according to said link bundle control packets includes: communicating data packets over each of the plurality of links. In one embodiment, said operation of communicating said one or more link bundle control packets identifying the operational state of the link bundle as being active includes: communicating a link bundle control packet of said one or more link bundle control packets including said identification of the operational state of the link bundle being active over each of the plurality of links.

In one embodiment, said one or more link bundle control packets include an identification of an operational state of the link bundle as being inactive. In one embodiment, the second device ceases to consider the operational state of the link bundle as being active in response to at least one of said one or more link bundle control packets including the identification of the operational state of the link bundle as being inactive. In one embodiment, said using the link bundle according to said link bundle control packets includes: ceasing to communicate data packets over the link bundle. One embodiment includes: in response to determining that the number of active links of the plurality of links does not provide sufficient bandwidth, the first device performing said communicating operation of the operational state of the link bundle as being inactive.

In one embodiment, said operation of communicating said one or more link bundle control packets of the link bundle includes: communicating a link bundle control packet of said one or more link bundle control packets over each of the plurality of links. One embodiment includes: in response to the first device receiving from the second device over the link bundle a particular link bundle control packet including an identification that the operational state of the link bundle is inactive, the first device ceasing to send data packets over the link bundle to the second device.

One embodiment includes: communicating, from the first device to the second device, one or more link control packets over links of the plurality of links, with each of said one or more link control packets being directed at the operation of the particular link over which it is being said communicated from the first device to the second device. In one embodiment, said one or more link control packets include a plurality of link particular ordering packets; wherein each link particular ordering packet of the plurality of link particular ordering packets is sent over a different one of the plurality of links and specifies a link bundle ordering for said different one of the plurality of links. In one embodiment, said one or more link control packets each include one or more values representing a rate at which the second device should send information to the first device across the particular link over which said link control packet is being said communicated from the first device to the second device, or include one or more values representing a rate at which the first device is sending information to the second device over which said rate control packet is being said communicated from the first device to the second device.

One embodiment performs a method, which includes: communicating, from a first device to a second device, one or more link control packets over each particular link of one or more of a plurality of links of a link bundle; wherein the link bundle includes the plurality of links with each link being coupled between the first device and the second device for communicating information; wherein said one or more link control packets include one or more values representing operational details for said particular link over which said link control packet is being said communicated; and communicating information by the first device with the second device, including operating each particular link of the link bundle according to said one or more link control packets including said operational details for said particular link.

In one embodiment, said one or more link control packets include a plurality of link particular ordering packets; wherein each link particular ordering packet of the plurality of link particular ordering packets is sent over a different one of the plurality of links and specifies a link bundle ordering for said different one of the plurality of links. In one embodiment, said link particular ordering packet for said different one of the plurality of links includes a link operational designation of active or standby, with at least two of said link particular ordering packets designating active; and at least one of said link particular ordering packets designating standby. In one embodiment, said link particular ordering packet for said different one of the plurality of links includes a link operational designation of active, standby, or hot standby, with at least one of said link particular ordering packets designating hot standby corresponding to data being able to be sent immediately without initialization operations over said at least one of said link particular ordering packets designating hot standby. In one embodiment, said link particular ordering packet for at least two of said different ones of the plurality of links includes a link operational designation of standby; and wherein the link bundle ordering provides an order for which to use said at least two of said different ones of the plurality of links for replacing other links of the plurality of links.

In one embodiment, said one or more link control packets include a plurality of link rate control packets; wherein each particular link rate control packet is sent over a different one of the plurality of links and specifies a rate at which the second device should send information to the first device across said different one of the plurality of links. In one embodiment, each of said the plurality of link rate control packets includes one or more values representing a rate at which the first device is sending information to the second device across said different one of the plurality of links. In one embodiment, said one or more link control packets include a plurality of link rate control packets; wherein each particular link rate control packet is sent over a different one of the plurality of links and specifies a rate at which the first device is sending information to the second device across said different one of the plurality of links.

One embodiment includes an apparatus, comprising: a bundle interface configured for communicating, from the apparatus to a second device, one or more link bundle control packets over a link bundle. The link bundle includes a plurality of links with each link being coupled between the apparatus and the second device for communicating information. These link bundle control packets are directed at the operation of the link bundle in its entirety, and are communicated over one or more of the plurality of links. The apparatus is configured to communicate information with the second device, including communicating over the link bundle according to said one or more link bundle control packets. In one embodiment, each of said one or more link bundle control packets includes a Bundle Information type-length-value element (TLV) specifying an operational state of the link bundle from a group of operational states comprising: an active state, and an inactive state.

One embodiment includes an apparatus, comprising: a bundle interface configured for communicating, from the apparatus to a second device, one or more link control packets over each particular link of one or more of a plurality of links of a link bundle. The link bundle includes the plurality of links with each link being coupled between the apparatus and the second device for communicating information. These link control packets include one or more values representing operational details for said particular link over which said link control packet is being said communicated. The apparatus is configured for communicating information to the second device, including operating each particular link of the link bundle according to said one or more link control packets including said operational details for said particular link. In one embodiment, each of said one or more link control packets includes a Member Information type-length-value element (TLV) specifying a particular link ordering. In one embodiment, each of said one or more link control packets includes a Rate Information type-length-value element (TLV) specifying a rate at which the apparatus is sending packets to the second device over the link bundle, and specifying a rate at which the second device is requested to send packets to the apparatus.

### 2. Description

Disclosed are, inter alia, methods, apparatus, computer-storage media, mechanisms, and means associated with signaling describing the operation of a link bundle. Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc. may comprise one or more embodiments, which may include some elements or limitations of a claim being performed by the same or different systems, devices, components, etc. A processing element may be a general processor, task-specific processor, or other implementation for performing the corresponding processing. The embodiments described hereinafter embody various aspects and configurations, with the figures illustrating exemplary and non-limiting configurations. Note, computer-readable media and means for performing methods and processing block operations (e.g., a processor and memory or other apparatus configured to perform such operations) are disclosed and are in keeping with the extensible scope and spirit of the embodiments. Note, the term “apparatus” is used consistently herein with its common definition of an appliance or device.

Note, the steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value - the value must be obtained prior to processing it, although some of the associated processing may be performed prior to, concurrently with, and/or after the read operation). Also note, nothing described or referenced in this document is admitted as prior art to this application unless explicitly so stated.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc. are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

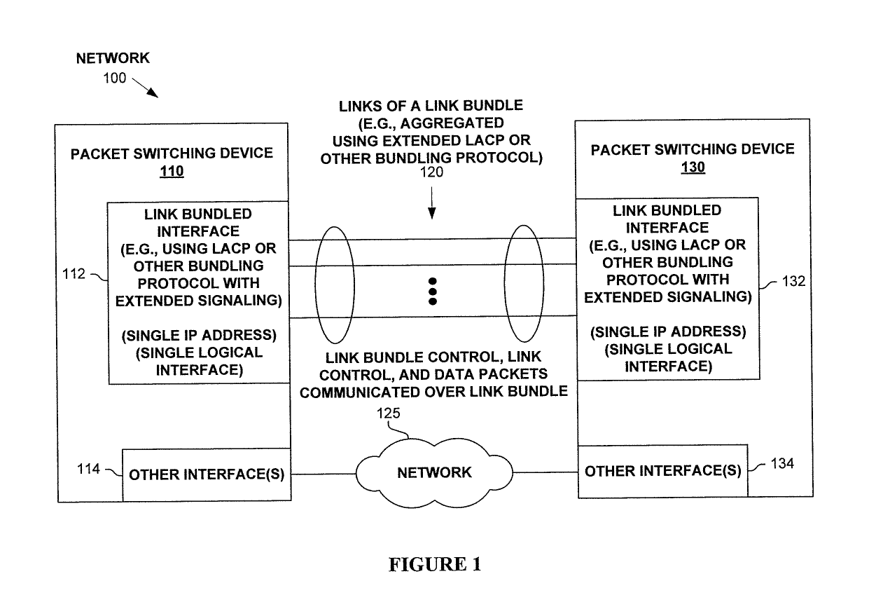

Expressly turning to the figures, FIG. 1 illustrates a network 100 operating according to one embodiment. As shown, network 100 includes packet switching device 110 communicatively coupled with packet switching device 130 over link bundle 120. Additionally, packet switching device 110 is communicatively coupled with packet switching device 130 also over network 125, which is used in one embodiment when link bundle 120 is operatively inactive, or possibly in addition to an active link bundle 120. As shown, packet switching device 110 includes a link bundle interface 112, and other interfaces 114; and packet switching device 130 includes a link bundle interface 132, and other interfaces 134.

One embodiment implements link bundle 120 by link bundle interfaces 112 and 132 operating and signaling according to an extension of Link Aggregation Control Protocol (LACP as referred to in one or more IEEE standardization committees and/or specifications), or other link bundling protocol. In one embodiment, this extension includes the use of link bundle control packets and/or link control packets. Link bundle interfaces 112 and 132 operate link bundle 120 according to these link bundle control packets and/or link control packets.

LACP (as well as other link bundling protocols) provides a method to control the bundling of several physical ports together to form a single logical channel. LACP allows a network device to negotiate an automatic bundling of links by sending LACP packets to the peer (directly connected device that also implements LACP). One embodiment extends LACP (or another link bundling protocol) to include link bundle control packets directed at the operation of the link bundle in its entirety. One embodiment extends LACP (or another link bundling protocol) to include link control packets to directed at the operation of individual links of the link bundle.

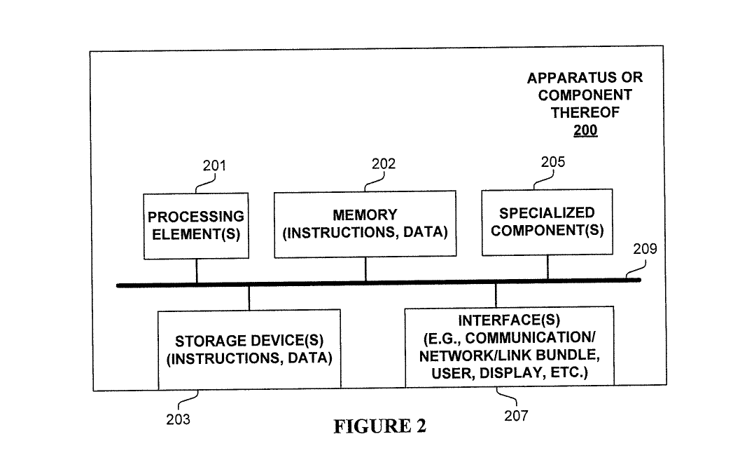

FIG. 2 is block diagram of an apparatus, device, or component 200 used in one embodiment associated with signaling describing the operation of a link bundle, with this signaling including link bundle control packets and/or link control packets as part of the link aggregation protocol used in controlling the link bundle in its entirety, and individual links of the link bundle. In one embodiment, apparatus or component 200 performs one or more processes corresponding to one of the flow diagrams illustrated or otherwise described herein. In one embodiment, apparatus or component 200 performs functionality of one or more apparatus or components thereof illustrated or otherwise described herein. In one embodiment, apparatus or component 200 creates, communicates, and reacts to link bundle control packets and/or link control packets illustrated or otherwise described herein. These link bundle control packets and/or link control packets may include fields in the format of the TLVs illustrated or otherwise described, or take on other formats in order to perform the requisite signaling over the link bundle to control the link bundle in its entirety, or individual links thereof.

In one embodiment, apparatus or component 200 includes one or more processing element(s) 201, memory 202, storage device(s) 203, specialized component(s) 205 (e.g. optimized hardware such as for performing operations, etc.), and interface(s) 207 (e.g., link bundle or other interfaces) or communicating information (e.g., sending and receiving link bundle control packets and/or link control packets, sending and receiving data and/or control packets, user-interfaces, displaying information, etc.), which are typically communicatively coupled via one or more communications mechanisms 209, with the communications paths typically tailored to meet the needs of the application. In one embodiment apparatus or component 200 corresponds to, or is part of, packet switching device 110 or 130 (including, but not limited to link bundle interfaces 112 and/or 132) of FIG. 1.

Various embodiments of apparatus or component 200 may include more or less elements. The operation of apparatus or component 200 is typically controlled by processing element(s) 201 using memory 202 and storage device(s) 203 to perform one or more tasks or processes. Memory 202 is one type of computer-readable/computer-storage medium, and typically comprises random access memory (RAM), read only memory (ROM), flash memory, integrated circuits, and/or other memory components. Memory 202 typically stores computer-executable instructions to be executed by processing element(s) 201 and/or data which is manipulated by processing element(s) 201 for implementing functionality in accordance with an embodiment. Storage device(s) 203 are another type of computer-readable medium, and typically comprise solid state storage media, disk drives, diskettes, networked services, tape drives, and other storage devices. Storage device(s) 203 typically store computer-executable instructions to be executed by processing element(s) 201 and/or data which is manipulated by processing element(s) 201 for implementing functionality in accordance with an embodiment.

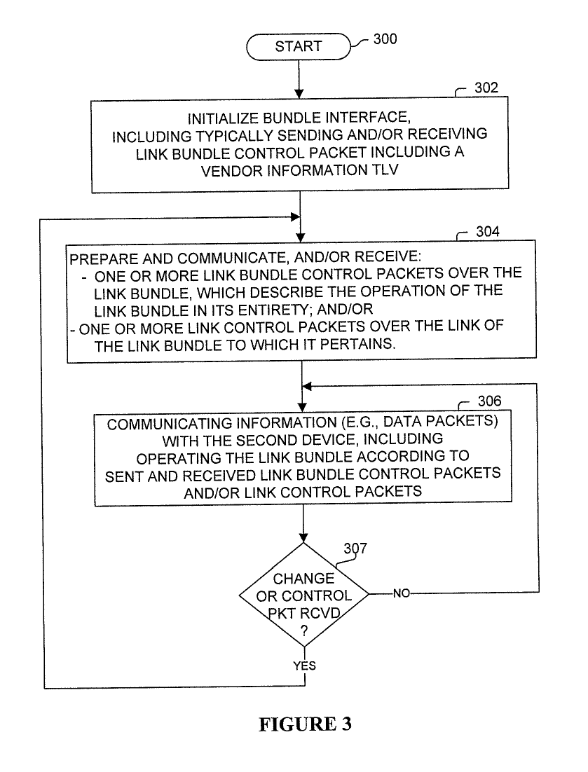

FIG. 3 illustrates a process performed in one embodiment. Processing begins with process block 300. In process block 302, the link bundle interface is initialized, which typically includes sending and/or receiving one or more link bundle control packets and/or link control packets. Note, typically a link control packet is sent over the link of the link bundle to which its included control information pertains. As part of this initialization, one embodiment sends one or more link bundle control packets which include a vendor information type-length-value element (TLV), which allows each end of the link bundle to understand what functionality the other end of the link bundle supports, so the link bundle can be operated accordingly.

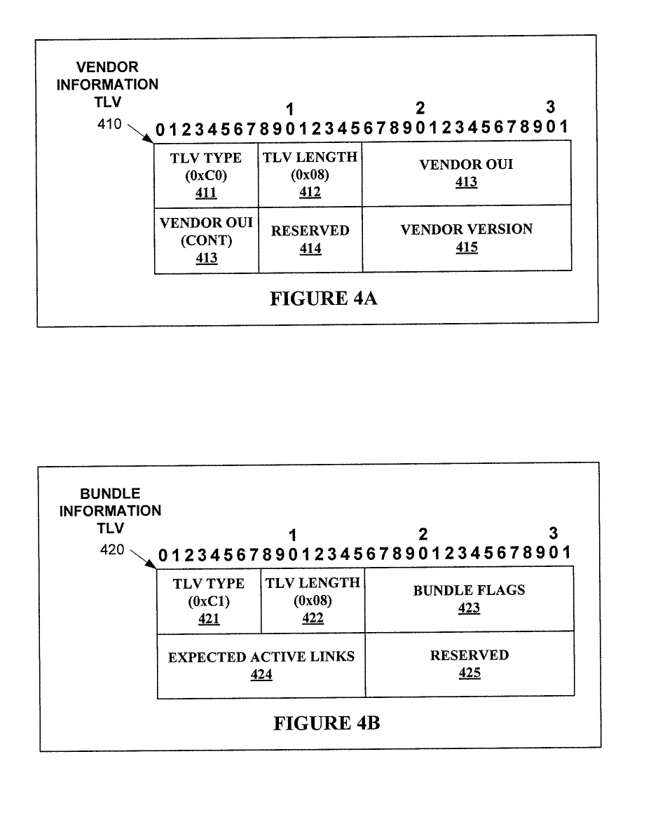

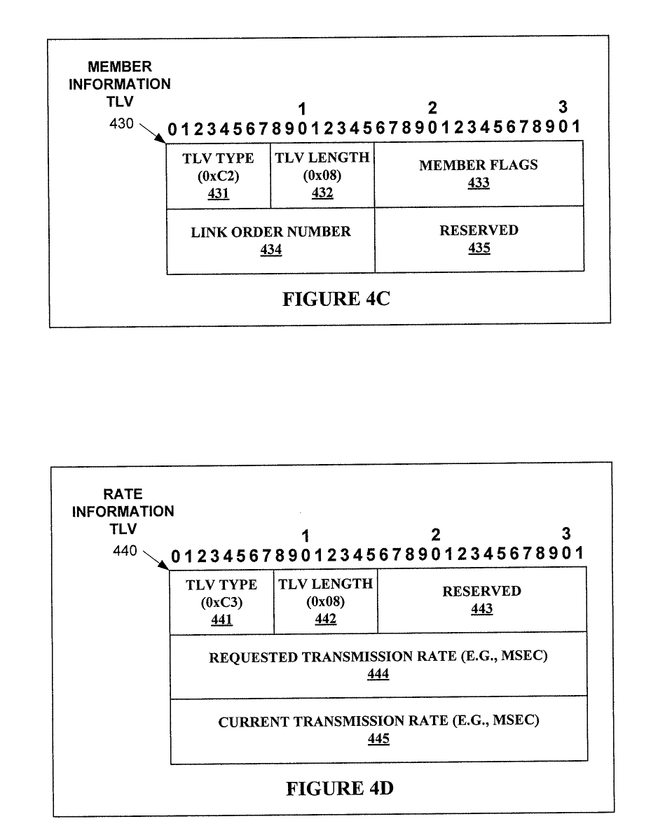

Examples of TLVs contained in these link bundle control packets in one embodiment include, but are not limited to, those illustrated in FIGS. 4A and/or 4B. Note, in one embodiment, one or both of the TLVs illustrated in FIGS. 4A and 4B are communicated in link control packets. Also note, in one embodiment, all or part of the information shown in a TLV illustrated in FIGS. 4A and 4B is communicated over the link bundle in a link bundle control packet, link control packet, and/or other packet.

An example of this vendor information TLV used in one embodiment is Vendor Information TLV 410 of FIG. 4A. As shown, Information TLV 410 includes an identifying TLV type 411 (0xC0 in this example), TLV length 412 (8 bytes in this example), Vendor Organizationally Unique Identifier 413 (Vendor OUI), Reserved 414, and Vendor Version 415. Vendor OUI 413 identifies the particular vendor of the sender of Vendor Information TLV 410, and Vendor Version 415 identifies a version of the link bundle control protocol (e.g., typically including which version of link bundle control packets and/or link control packets) that the sender of Vendor Information TLV 410 will be communicating to the device on the other end of the link bundle. A link bundle control packet including Vendor Information TLV 410 may be sent over a single, more than one but less than all, or all of the links of the link bundle.

Returning to FIG. 3, processing continues with process block 304, wherein one or more link bundle control packets and/or link control packets are prepared and sent and/or received. These link bundle control packets describe the operation of the link bundle in its entirety; while these link control packets describe the operation of the link over which it is sent or received. Note, additionally other control packets (e.g., LACP or other protocol packets) may be sent and received.

FIG. 4B illustrates a Bundle Information TLV 420. As shown, Bundle Information TLV 420 includes an identifying TLV type 421 (0xC1 in this example), TLV length 422 (8 bytes in this example), Bundle Flags 423, Expected Active Links 424, and Reserved 425. Typically, a link bundle control packet including an identical Bundle Information TLV 420 is sent over all active links in the link bundle. However, in case of transient differences for example, the receiving by the highest-priority link of the link bundle will be controlling in one embodiment.

In one embodiment, Bundle Flags 423 includes either a first value (e.g., 0x0001) signifying that the link bundle is inactive; or a second value (e.g., 0x0002) signifying that the link bundle is active. In one embodiment, when the link bundle is active, data packets are communicated over the active links of the link bundle in a predefined order (e.g., that specified in a load balancing table).

In one embodiment, Expected Active links 424 specifies the number of links in the link bundle which would normally be active in the link bundle if all configured links are functioning as expected. This typically will match the configured maximum active links value for the link bundle. Note, the devices on both ends of the link bundle typically will use the lower value of Expected Active links 424 and the configured maximum active links value.

Examples of TLVs contained in these link control packets in one embodiment include, but are not limited to, those illustrated in FIGS. 4C and/or 4D. Note, in one embodiment, one or both of the TLVs illustrated in FIGS. 4C and 4D are communicated in link bundle control packets. Also note, in one embodiment, all or part of the information shown in a TLV illustrated in FIGS. 4C and 4D is communicated over the link bundle in a link bundle control packet, link control packet, and/or other packet.

FIG. 4C illustrates a Member Information TLV 430. As shown, Member Information TLV 430 includes an identifying TLV type 431 (0xC2 in this example), TLV length 432 (8 bytes in this example), Member Flags 433, Link Order Number 434, and Reserved 435. In one embodiment, a link bundle control packet containing the customized Member Information TLV 430 is sent over each link of the link bundle so the receiver of the link bundle control packet can identify information that corresponds to the link over (and corresponding port on) which it was received. In one embodiment, the link bundle member information for multiple links of the link bundle is consolidated and sent in a same packet.

As shown in FIG. 4C, Member Information TLV 430 of one embodiment includes Member Flags 443. In one embodiment, Member Information TLV 430 includes either a first value (e.g., 0x0001) specifying that the link is designated a “protect” link, or a second value (e.g., 0x0002) specifying that the link is designated a “working”/“active” link. In one embodiment, Member Information TLV 430 includes a first value (e.g., 0x0001) specifying that the link is designated a “protect” link, a second value (e.g., 0x0002) specifying that the link is designated a “working”/“active” link, or a third value (e.g., 0x0004) specifying that the link is designated a “hot standby.”

A hot-standby link is a link that is ready to take over immediately on the failure of a working/active link if the hot-standby designation has been received on this link from the other end of the link bundle (effectively acknowledging that both ends of the link bundle are ready to immediately receive data thereon). Otherwise, it is treated as a protect link, which (unlike the on a hot-standby link) requires initialization operations to be performed before data packets can be sent over the now working/active, previous protect link of the link bundle.

Further, Member Information TLV 430 of one embodiment includes Link Order Number (field) 434. This field 434 specifies the ordering of the link in the load-balance table for the link bundle. When applied to the system, the Link Order Numbers are unique within the link bundle (or at least unique within the classes of working and protect/hot standby), and typically will be in the range of zero to <expected number of links minus one>, or using some other encoding to be able to identify a deterministic ordering of the active links, and a deterministic ordering of the protect/hot standby links used in replacing a failed or otherwise taken out of service previously active link.

In one embodiment, though the use of Member Information TLVs 430, the receiver of packets transmitted over the link bundle understands the ordering of the links that the sender is using to distribute packets among the links of the link bundle. Hence, the receiver will understand the pattern of distribution if it knows the distribution methodology of the sender. In one embodiment, this distribution methodology is a function of the vendor and/or version, such as that communicated in Vendor Information TLV 410 (FIG. 4A).

Thus, one embodiment uses TLV 430 as a means for acquiring information that it can use to ensure that traffic for a packet flow uses the same link in both directions, or possibly avoids a particular link in one or both directions. Also, one embodiment uses TLV 430 as a means for acquiring information that can be used by the sender and receiver to construct a consistently ordered load balance table such that with appropriate use of hash functions by the two devices traffic relating to a particular flow (identified, for example, by the source and destination addresses in an IP packet) would be sent on the same link in both directions.

Also, by establishing a same deterministic ordering of protect/hot standby links, both ends of the link bundle will know and use in the same order the protect/hot standby links to replace a previously active/working link of the link bundle.

FIG. 4D illustrates a Rate Information TLV 440. As shown, Rate Information TLV 440 includes an identifying TLV type 441 (0xC3 in this example), TLV length 442 (8 bytes in this example), Reserved 443, Requested Transmission Rate 444, and Current Transmission Rate 445.

In one embodiment, Requested Transmission Rate 444 specifies the rate (e.g., in milliseconds) at which the other end of the link bundle should send data packets (possibly subject to local capabilities/configuration). If only a few specific rates are supported, then typically the rate selected must not be faster than the requested rate to avoid overloading the requesting device.

In one embodiment, Current Transmission Rate 445 specifies the rate (e.g., in milliseconds) at which the sender of the Rate Information TLV 440 is currently sending data packets over the link bundle. In one embodiment, Current Transmission Rate 445 specifies the amount of time until the next data packet should be expected to arrive at the other end of the link bundle.

Using Rate Information TLVs, the two end devices of the link bundle can negotiate and change the rate at which data packets are sent in each direction over the link bundle.

Returning to FIG. 3, processing of process block 304 is complete as one or more link bundle control packets have been communicated (in one or both directions) to provide control information describing the operation of the link bundle in its entirety and/or individual links of the link bundle. In process block 306, information (e.g., data packets) is communicated over the link bundle with the other end device in accordance with the link bundle configuration information communicated in one or more of the link bundle control packets. As determined in process block 307, if a change has occurred which requires one or more link bundle control packets to be sent to the other end or one or more link bundle control packets have been received, then processing returns to process block 304, else processing continues with process block 306.

In one embodiment, the determination in process block 307 includes one end of the link bundle determining that the link bundle should be changed the active or inactive state. For example, it is possible that one link bundle interface may determine that the link bundle is inactive, while the other end has not made the same determination. For example, if one end of the link bundle is using Bidirectional Forwarding Detection and the other end of the link bundle is not, only one link bundle interface may consider the link bundle as inactive while the other link bundle interface continues to transmit traffic. Also, different configurations of each of the link bundle interfaces may lead to a same situation where one side operates as if the link bundle is active, while the other side operates as if the link bundle is inactive. Such different configurations may include, but are not limited to, the minimum bandwidth available or minimum number of active links in the link bundle required to consider the link bundle as being active. Thus, one link bundle interface may determine that the number of currently active links in the link bundle does not provide enough bandwidth required for using the link bundle for communication (e.g., the number of links or their aggregate bandwidth have fallen below a predetermined threshold value). Therefore, this link bundle interface will consider the link bundle as being inactive (e.g., down), while the link bundle interface on the other side considers the link bundle as active (e.g., up) and continues to transmit packets over the link bundle, which are lost by the receiver considering the link bundle as inactive.

In such case, processing of the flow diagram of FIG. 3 returns to process block 304, which includes sending one or more link bundle control packets over one or more (but typically all) of the links of the link bundle which can communicate information. Thus, in one embodiment, these one or more link bundle control packets include Bundle Information TLV 420 (FIG. 4B) specifying in Bundle Flags 423 that the link bundle is down (e.g., a value of 0x0001). In this manner, as soon as one device (e.g., its bundle interface) considers the link bundle as being inactive, it communicates this state information to the other end of the link bundle. This avoids a prolonged condition where one side uses the link bundle as if it were in an active operative state, while the other side uses the link bundle as if it were in an inactive operative state. This will typically reduce the amount of traffic loss, and obviates the need of the timeout of a higher-level protocol to recognize this traffic loss condition.

In view of the many possible embodiments to which the principles of the invention may be applied, it will be appreciated that the embodiments and aspects thereof described herein with respect to the drawings/figures are only illustrative and should not be taken as limiting the scope of the invention. For example, and as would be apparent to one skilled in the art, many of the process block operations can be re-ordered to be performed before, after, or substantially concurrent with other operations. Also, many different forms of data structures could be used in various embodiments. The invention as described herein contemplates all such embodiments as may come within the scope of the following claims and equivalents thereof.

What is claimed is:

1. A method, comprising:
communicating, by a first device with a second device, one or more link bundle control packets over a link bundle; wherein the link bundle includes a plurality of links, with each of the plurality of links being coupled between the first device and the second device; wherein said one or more link bundle control packets are directed at the operation of the link bundle in its entirety; and wherein said one or more link bundle control packets are communicated over one or more of the plurality of links; and
communicating information by the first device with the second device over the link bundle operated according to control information included in said one or more link bundle control packets.

2. The method of claim 1, wherein said one or more link bundle control packets includes an identification of an operational state of the link bundle as being active.

3. The method of claim 2, wherein said operation of communicating information includes communicating data packets over each of the plurality of links.

4. The method of claim 3, wherein said operation of communicating said one or more link bundle control packets identifying the operational state of the link bundle as being active includes: communicating a link bundle control packet, including said identification of the operational state of the link bundle being active, of said one or more link bundle control packets over each of the plurality of links.

5. The method of claim 1, wherein said one or more link bundle control packets include an identification of an operational state of the link bundle as being inactive.

6. The method of claim 5, wherein the second device ceases to consider the operational state of the link bundle as being active in response to at least one of said one or more link bundle control packets including the identification of the operational state of the link bundle as being inactive.

7. The method of claim 5, wherein said operation of communicating information includes ceasing to communicate data packets over the link bundle.

8. The method of claim 5, comprising: in response to determining that the number of active links of the plurality of links does not provide sufficient bandwidth, the first device performing said communicating operation of the operational state of the link bundle as being inactive.

9. The method of claim 1, wherein said operation of communicating said one or more link bundle control packets of the link bundle includes: communicating a link bundle control packet of said one or more link bundle control packets over each of the plurality of links.

10. The method of claim 1, comprising: in response to the first device receiving from the second device over the link bundle a particular link bundle control packet including an identification that the operational state of the link bundle is inactive, the first device ceasing to send data packets over the link bundle to the second device.

11. The method of claim 1, comprising: communicating, from the first device to the second device, one or more link control packets over links of the plurality of links, with each particular link control packet of said one or more link control packets being directed at the operation of the particular link over which said particular link control packet is being said communicated from the first device to the second device.

12. The method of claim 11, wherein said one or more link control packets includes a plurality of link particular ordering packets; wherein each link particular ordering packet of the plurality of link particular ordering packets is sent over a different one of the plurality of links and specifies a link bundle ordering for said different one of the plurality of links.

13. The method of claim 11, wherein said one or more link control packets each include one or more values representing a rate at which the second device should send information to the first device across the particular link over which said link control packet is being said communicated from the first device to the second device, or include one or more values representing a rate at which the first device is sending information to the second device over which said rate control packet is being said communicated from the first device to the second device.

14. A method, comprising:
communicating, from a first device to a second device, one or more link control packets over each particular link of one or more of a plurality of links of a link bundle;
wherein the link bundle includes the plurality of links, with each link of the plurality of links being coupled between the first device and the second device; wherein said one or more link control packets include one or more values representing operational details for said particular link over which said link control packet is being said communicated; and
communicating information by the first device with the second device over the link bundle, with each particular link of the link bundle operated according to said operational details said represented in said one or more link control packets.

15. The method of claim 14, wherein said one or more link control packets include a plurality of link particular ordering packets; wherein each link particular ordering packet of the plurality of link particular ordering packets is sent over a different one of the plurality of links and specifies a link bundle ordering for said different one of the plurality of links.

16. The method of claim 15, wherein said link particular ordering packet for said different one of the plurality of links includes a link operational designation of active or standby, with at least two of said link particular ordering packets designating active; and at least one of said link particular ordering packets designating standby.

17. The method of claim 15, wherein one or more of said link particular ordering packets for said different one of the plurality of links includes a link operational designation of active, standby, or hot standby, with at least one of said link particular ordering packets designating hot standby corresponding to data being able to be sent immediately without initialization operations over said at least one of the plurality of links having been designated as a hot standby.

18. The method of claim 15, wherein said link particular ordering packet for at least two of said different ones of the plurality of links includes a link operational designation of standby; and wherein the link bundle ordering provides an order for which to use said at least two of said different ones of the plurality of links for replacing other links of the plurality of links.

19. The method of claim 14, wherein said one or more link control packets include a plurality of link rate control packets; wherein each particular link rate control packet is sent over a different one of the plurality of links and specifies a rate at which the second device should send information to the first device across said different one of the plurality of links.

20. The method of claim 14, wherein each of said the plurality of link rate control packets includes one or more values representing a rate at which the first device is sending information to the second device across said different one of the plurality of links.

21. The method of claim 14, wherein said one or more link control packets include a plurality of link rate control packets; wherein each particular link rate control packet is sent over a different one of the plurality of links and specifies a rate at which the first device is sending information to the second device across said different one of the plurality of links.

22. An apparatus, comprising:
a bundle interface configured for communicating, by the apparatus with a second device, one or more link bundle control packets over a link bundle; wherein the link bundle includes a plurality of links with each link of the plurality of links being coupled between the apparatus and the second device; wherein said one or more link bundle control packets are directed at the operation of the link bundle in its entirety; and wherein said one or more link bundle control packets are communicated over one or more of the plurality of links; and
wherein the apparatus is configured to communicate information with the second device over the link bundle operated according to control information included in said one or more link bundle control packets.

23. The apparatus of claim 22, wherein each of said one or more link bundle control packets includes a Bundle Information type-length-value element (TLV) specifying an operational state of the link bundle from a group of operational states comprising: an active state, and an inactive state.

24. An apparatus, comprising:
a bundle interface configured for communicating, from the apparatus to a second device, one or more link control packets over each particular link of one or more of a plurality of links of a link bundle; wherein the link bundle includes the plurality of links with each of the plurality of links being coupled between the apparatus and the second device; wherein said one or more link control packets include one or more values representing operational details for said particular link over which said link control packet is being said communicated; and
wherein the apparatus is configured to communicate information with the second device over the link bundle, with each particular link of the link bundle operating according to said operational details for said particular link included in at least one of said one or more link control packets.

25. The apparatus of claim 24, wherein each of said one or more link control packets includes a Member Information type-length-value element (TLV) specifying a particular link ordering.

26. The apparatus of claim 24, wherein each of said one or more link control packets includes a Rate Information type-length-value element (TLV) specifying a rate at which the apparatus is sending packets to the second device over the link bundle, and specifying a rate at which the second device is requested to send packets to the apparatus.
